(19) United States
(12) Patent Application Publication
(10) Pub. No.: US 2026/0141829 A1
(43) Pub. Date: May 21, 2026

(54) AUGMENTED REALITY-BASED WINDOW WITH ACTIVE CONTROL ELEMENTS

(71) Applicant: Sony Interactive Entertainment Inc., Tokyo (JP)

(72) Inventor: Michael Padilla, San Mateo, CA (US)

(21) Appl. No.: 18/954,849

(22) Filed: Nov. 21, 2024

(51) Int. Cl. G09G 3/00; B60J 3/04

(52) U.S. Cl. CPC G09G 3/001; B60J 3/04; G09G 2320/0626; G09G 2354/00; G09G 2360/144; G09G 2380/10

(57) ABSTRACT

A vehicle window can include a transparent display assembly with active control elements. The transparent display assembly can be used by vehicle passengers to play video games under normalized backlight conditions that do not corrupt the game images. Thus, in one particular example, a computing device can receive input from first and second optical sensors that are disposed at different locations on the transparent display assembly. Based on the input, the computing device can then determine respective opaqueness parameters for first and second pixels of the transparent display assembly. The computing device can then control the first and second pixels according to the respective opaqueness parameters to normalize backlight in relation to one or more images presented on the transparent display assembly. The computing device can also account for user head pose and interior vehicle lighting if desired.

### FIELD

The disclosure below relates to technically inventive, non-routine solutions that are necessarily rooted in computer technology and that produce concrete technical improvements. In particular, the disclosure below relates to augmented reality-based transparent display windows with active control elements.

### BACKGROUND

Vehicle hardware is becoming increasingly sophisticated, including in the integration of transparent displays into the windows of the vehicle. However, as recognized herein, vehicle software still leaves much to be desired and does not optimize use of this hardware. Accordingly, no adequate solutions currently exist to the foregoing computer-related, technological problem.

### SUMMARY

The disclosure below further recognizes that additional hardware may be included in transparent window displays in combination with the technical software improvements disclosed herein for an even more robust and optimized display device.

Accordingly, in one aspect an apparatus includes at least one processor system configured to receive first input from a first optical sensor and second input a second optical sensor. The first optical sensor is located at a first location on a transparent display assembly, and the second optical sensor is located at a second location on the transparent display assembly. The at least one processor system is also configured to process the first input to determine a first opaqueness parameter for a first pixel of the transparent display assembly, and to process the second input to determine a second opaqueness parameter for a second pixel of the transparent display assembly. The first pixel is adjacent to the first location and the second pixel is adjacent to the second location. Based on the determinations, the at least one processor system is configured to then control the first pixel according to the first opaqueness parameter and to control the second pixel according to the second opaqueness parameter.

In various example implementations, the transparent display assembly may be integrated into a window of a vehicle.

Also in various examples, the first and second inputs may be processed to maintain a normalized brightness level for an image presented on the transparent display assembly using the first and second pixels. Thus, in some instances, the first opaqueness parameter may indicate a different opaqueness amount than the second opaqueness parameter to normalize brightness levels between the two pixels.

Furthermore, the at least one processor system may be configured to process the first input to identify a first brightness level of light impinging on the first optical sensor, to determine the first opaqueness parameter to compensate for the first brightness level, to process the second input to identify a second brightness level of light impinging on the second optical sensor, and to determine the second opaqueness parameter to compensate for the second brightness level.

In some specific implementations, the at least one processor system may even be configured to execute a model to process the first and second inputs to determine the first and second opaqueness parameters. So, if desired, the at least one processor system may be configured to, based on a first brightness level of light currently impinging on the first optical sensor, extrapolate a second brightness level of light to impinge a third location of the transparent display assembly at a future time. Based on a third brightness level of light currently impinging on the second optical sensor, the at least one processor system may also be configured to extrapolate a fourth brightness level of light to impinge a fourth location of the transparent display assembly at the future time. Then at the future time, the at least one processor system may be configured to control opaqueness of a third pixel according to a third opaqueness parameter for the second brightness level, and to control opaqueness of a fourth pixel according to a fourth opaqueness parameter for to the fourth brightness level.

In some example embodiments, the apparatus may include the transparent display assembly. The first and second optical sensors themselves may include photodiodes in non-limiting embodiments, though other types of optical sensors may also be used.

In another aspect, a method includes receiving input from first and second optical sensors that are disposed at different locations on a transparent display assembly. Based on the input, the method includes determining respective opaqueness parameters for first and second pixels of the transparent display assembly. The method then includes controlling the first and second pixels according to the respective opaqueness parameters to normalize backlight in relation to one or more images presented on the transparent display assembly.

In some examples, the method may include determining a head pose of a passenger of a vehicle and, based on the head pose, selecting the first and second pixels to control the first and second pixels according to the respective opaqueness parameters. The method may further include, in some cases, identifying one or more metrics for interior lighting within the vehicle and then determining the respective opaqueness parameters based on the one or more metrics for interior lighting.

In various instances, a first opaqueness parameter for the first pixel may be less than a second opaqueness parameter for the second pixel such that application of the first opaqueness parameter allows a first amount of light through the first pixel. Conversely, the second opaqueness parameter may be more than the first opaqueness parameter such that application of the second opaqueness parameter concurrently allows a second amount of light through the second pixel. The first and second amounts of light may be the same to within a threshold luminance.

Also in some example embodiments, the method may then include executing a model using the input to infer the respective opaqueness parameters for application at the first and second pixels at a time T1, with the time T1 being later than a time T0 at which light impinges on the first and second optical sensors to generate the input.

In still another aspect, an apparatus includes at least one computer readable storage medium (CRSM) that is not a transitory signal. The at least one CRSM includes instructions executable by a processor system to receive input from first and second optical sensors that are disposed at different locations on a transparent display assembly. Based on the input, the instructions are executable to determine respective opaqueness parameters for first and second pixels of the transparent display assembly. The instructions are then executable to control the first and second pixels according to the respective opaqueness parameters to modulate backlight in relation to one or more images presented on the transparent display assembly.

In some examples, the apparatus may include a vehicle, with the vehicle itself including the transparent display assembly as integrated into a window of the vehicle.

Also in examples where the transparent display is integrated into a window of a vehicle, the instructions may be executable to execute a video game configured for presentation in the vehicle. Here the instructions may then be executable to modulate the backlight while presenting the one or more images on the transparent display, where the one or more images are associated with the video game.

What's more, in some cases the instructions may be executable to determine a head pose of a passenger of a vehicle and, based on the head pose, select the first and second pixels to control the first and second pixels according to the respective opaqueness parameters.

Also in some cases, the instructions may be executable to execute a model to process head pose data, interior lighting data, and optical sensor input to infer the respective opaqueness parameters for locations of the transparent display at which light currently impinging the transparent display elsewhere will impinge the transparent display in the future. The instructions may then be executable to receive one or more outputs from the model that indicate the respective opaqueness parameters. Based on receipt of the outputs from the model, the instructions may then be executable to control the first and second pixels according to the respective opaqueness parameters.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows a plan view of a vehicle side window transparent display assembly with optical sensors consistent with present principles;

FIG. 3 shows a perspective view of the transparent display assembly from the perspective of a passenger inside the vehicle consistent with present principles;

FIG. 4 shows a perspective view of the transparent display assembly as it presents AR video game content consistent with present principles;

FIG. 5 is a schematic diagram of a person inside a vehicle while viewing content on a transparent display assembly consistent with present principles;

FIG. 6 is a schematic diagram of combined hardware and software operation consistent with present principles;

FIG. 7 shows example logic in example flow chart format that may be executed by an apparatus consistent with present principles; and

FIG. 8 shows example artificial intelligence (AI) architecture that may be implemented consistent with present principles.

### DETAILED DESCRIPTION

The detailed description below provides technical systems and methods for augmented reality-based windows with active control elements. The active control elements may include optical sensors and/or display pixels that can transition between opaque and transparent.

Accordingly, while a car window with a transparent display may otherwise have issues with glare, brightness, and color control absent present principles, the disclosure below employs a window display with active control elements that are used by the rendering device to modify outside-inside light transmission given player location inside the vehicle and interior vehicle lighting. Some or all aspects may be executed by an optimizer/coordination model that uses each active element in a coordinated manner.

Thus, if a non-driving passenger were playing an augmented reality (AR) video game on a side window display of a vehicle during nighttime driving, and a passing vehicle momentarily shined its headlights through that window, the active display elements may be controlled to selectively block or modulate the acute and momentary excess backlight from the headlights at display pixels that are presenting the game content so the user can still see the visual elements of the game content to play the game. Similarly, as the car turns during daytime driving, sunlight might streak across the side window, with the active display elements being controlled to block most of the sunlight to not over-light the presented AR game content. Thus, not only may brightness be controlled for the AR game images, but this also allows the AR game images to also be rendered with high-fidelity colors.

Also note here that, in non-limiting examples, the video game being played may be one be configured for presentation on the transparent window display. This may include game content specifically tailored for play within the moving vehicle, game content as formatted for presentation on transparent displays based on user head pose information, and/or AR content

However, it is also be understood that present principles for dynamic external backlight normalization over time may be applied to transparent displays for other implementations as well. Those implementations include, but are not limited to, transparent displays used for AR headsets, smart glasses donned on a person's head, and displays in the windows of buildings and other structures. But regardless of implementation, optical sensors located throughout the screen may still be used to understand what light is being received from the perspective of each gamer for the system to then control backlight in a synced way to create a consistent visual experience despite the inconsistent and transient external backlight.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

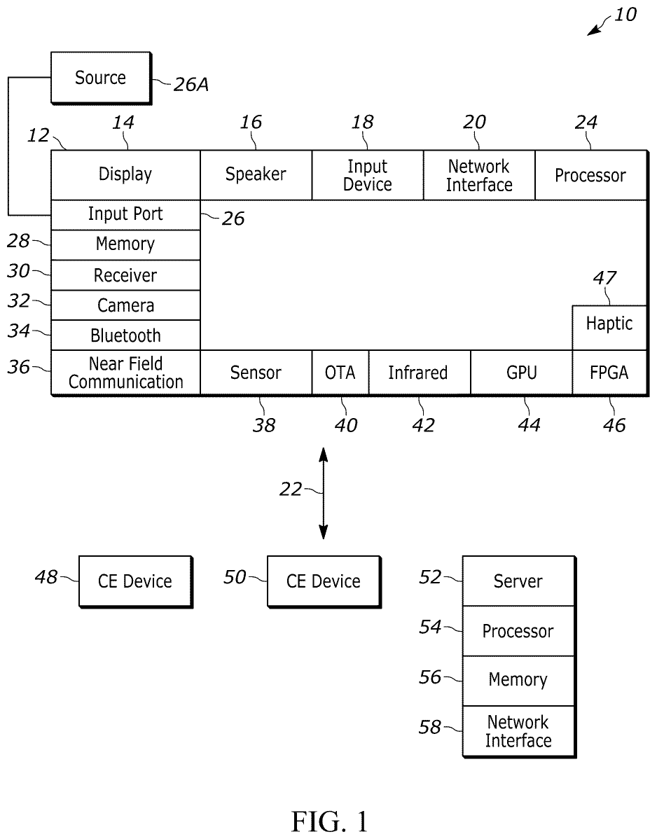

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12 consistent with present principles. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player, or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components discussed in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

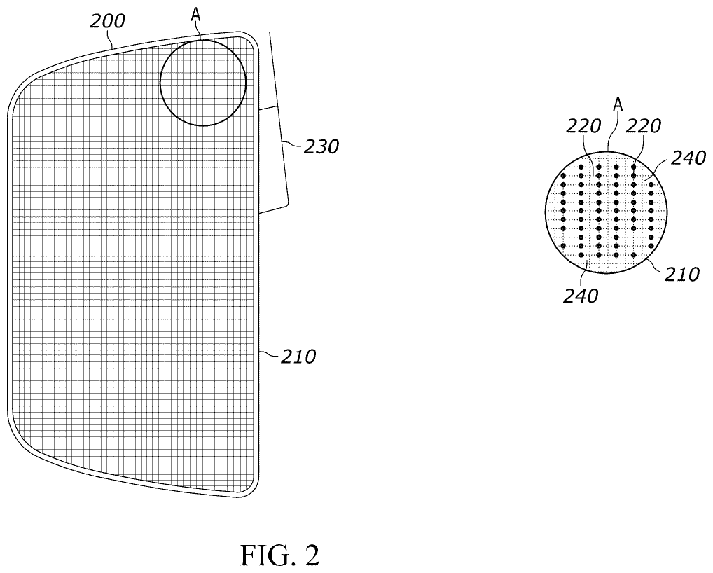

Now in reference to FIG. 2, an X-Y plan view is shown of a side window transparent display assembly 200 for a vehicle. It is to be understood that the surface shown in FIG. 2 is the outside surface of one of the vehicle's side windows as facing away from the vehicle itself when mounted thereon. However, further note that the transparent display assembly may be integrated into other windows as well, such as a front windshield or rear window of the vehicle.

As may be appreciated from FIG. 2, the assembly 200 includes a grid array 210 of connected optical sensors 220 whose sensing elements face outward away from the vehicle. The sensors 220 may be communicatively and electrically connected via communication lines and/or circuit wire to each other and to a computing device. The sensors 220 are best shown in Inset A of FIG. 2.

As shown in Inset A, the optical sensors 220 may be placed at intersections in the grid array 210 for high-fidelity external light tracking. The sensors 220 may be placed at each intersection for max high-fidelity light tracking, or may be located at every-other intersection in the X and/or Y dimensions to cut down on hardware requirements and processing load. Other configurations are also encompassed by present principles.

As for the sensors 220 themselves, each sensor 220 may be established by a photo diode, a fiberoptic sensor, or another type of optical sensor.

FIG. 2 also shows circuitry 230 for input from the sensors 220 to be communicated to the connected computing device. The connected computing device might be the vehicle's on-board entertainment system, a connected smartphone, and/or another client device.

The circuitry 230 may also be used to energize and deenergize liquid crystals in respective display pixels 240 that are located in another layer of the transparent display assembly. The bounds of each pixel may be aligned with the lines of the grid array 210 in the Z dimension for light to pass unobstructed through the cells in the array 210 and to each pixel. Therefore, note that in non-limiting examples, the pixel layer may be located, in the Z dimension, interior to the grid array 210 with the display assembly mounted on the vehicle such that the pixel layer is nearer the interior of the vehicle than the optical sensor layer.

The liquid crystals in each pixel 240 may have progressively increasing voltage applied through the circuitry 230 to make the respective pixel 240 increasingly more transparent, and may have progressively decreasing voltage applied to make the respective pixel 240 increasingly more opaque. Each pixel may therefore be separately and individually controllable by the computing device to let a different amount of backlight through at the same time as other pixels let other amounts of backlight through. Thus, voltage may be applied to each pixel on a per-pixel basis to let more or less backlight through the respective individual pixel based on external lighting conditions. The pixel layer itself may therefore be established by a transparent organic light-emitting diode (OLED) display, though other types of transparent displays with liquid crystals may also be used.

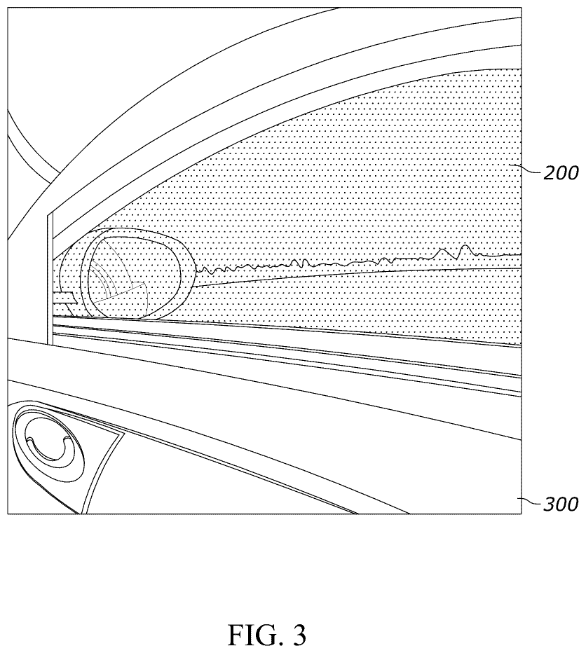

FIG. 3 shows a perspective view of the transparent display assembly 200 in situ on a vehicle 300, as seen by a vehicle passenger. It is to be understood that when the vehicle 300 is on and/or being driven, the optical sensors 220 may collect light readings indicating respective brightness levels for light impinging on each respective optical sensor 220 to then feed those light readings back to the computing device. Light that might impinge the window 300 during driving may include not only external ambient light but also external concentrated light from light sources like the sun, solar reflections from other objects, and headlights of other vehicles while driving at night.

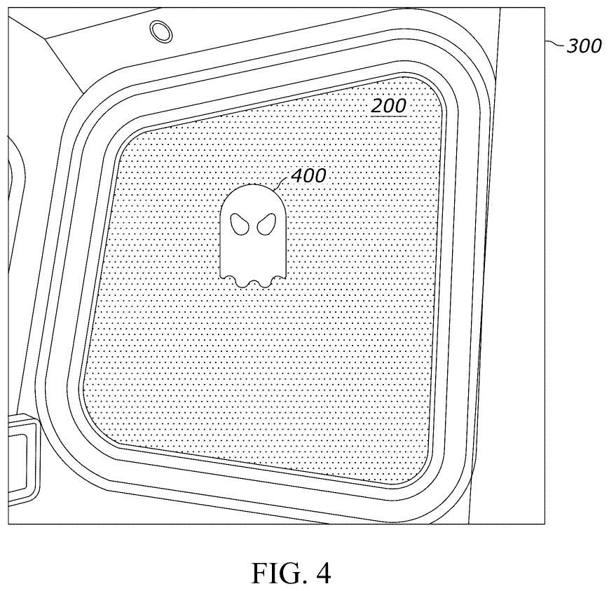

FIG. 4 then demonstrates that while the driver is driving the vehicle 300, the front passenger of the vehicle 300 may play an AR video game using the passenger side window assembly 200 as a game display to present game objects. In the present example, the game involves visually finding an AR virtual ghost 400 that is presented on the assembly 200 using augmented reality (AR) software so that the ghost 400 appears embedded in real three dimensional (3D) space beyond the vehicle 200 itself at various real-world locations as the vehicle drives down the road.

Now suppose the vehicle 300 approaches an intersection while driving at night as the gamer continues to play the game. As such, another vehicle coming toward the vehicle 300 from the right side might momentarily shine its headlights through the passenger side window with integrated display 200, which would otherwise corrupt the contrast, color, and brightness of the ghost 400 as presented on the display assembly 200. However, in implementing present principles, the optical sensors 220 on the window display assembly 200 may sense the assembly locations at which the headlight light is impinging on the assembly 200 itself (and the potentially varying brightness levels at each location). The assembly 200 may then feed those inputs into an artificial intelligence (AI)-based coordination model that is configured to output respective opaqueness parameters for respective display pixels on the assembly 200. The opaqueness parameters may then be used to normalize the light from the headlights according to the passenger's current head pose, reducing extreme backlighting from the headlights. In this way, the assembly 200 may selectively block some or all light from the headlights from being transmitted through certain display pixels that are presenting the game objects but that are also in the passenger's line of sight to the headlights themselves.

The opaqueness parameters output by the model may therefore be used by the connected computing device to apply different voltages to the liquid crystals of different respective display pixels individually according to the respective opaqueness parameter for that pixel so that a uniform backlight brightness level may be achieved for the graphical object 400 (as presented using multiple pixels that might otherwise have different amounts of backlight due to the headlights). Thus, different opaqueness parameters may indicate voltage amounts that correspond to different amounts of light for each display pixel to let through, depending on the intensity of the external light impinging on that respective pixel as well as the viewing angle of the passenger. This improves the functioning of the display assembly 200 as it can therefore present a high-fidelity image with optimized color and brightness notwithstanding any inconsistent and transient backlight fluctuations due to external light sources.

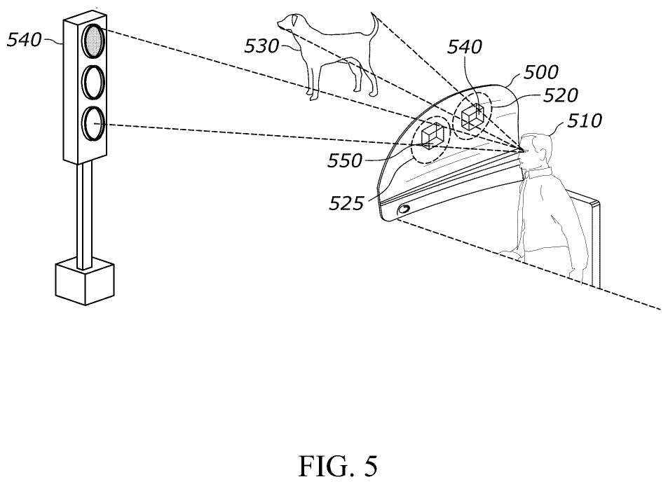

Now in reference to FIG. 5, a schematic diagram of a car window 500 and passenger/gamer 510 are shown, with the gamer 510 being located within the car on which the window 500 is mounted. Note that the window 500 may embody a transparent display assembly with optical sensors consistent with present principles. It is to be further understood consistent with FIG. 5 that the gamer 510 is actively playing a video/computer game and, as such, first and second graphical objects 520, 525 are presented on the window 500. Other portions of the window 500 may present no content on them such that they remain transparent without graphical objects blocking the passenger's view to the external world. It is to also be understood that the objects 520, 525 as rendered on the window 500 may be rendered with particular colors and brightness levels indicated by the game engine such that the computing device will continuously work to normalize backlight to maintain those levels.

Now suppose the objects 520, 525 are being presented on the window 500 while the vehicle travels down the road at night such that two real-world objects 530, 540 come within view of the gamer 510 through the window 500. The object 530 might be a very dimly-lit external object that does not emit its own light, such as a trash can or animal. The object 540 may be a very bright external object, such as an illuminated traffic light or illuminated headlight of another vehicle. Based on the gamer's current head pose and head location, the graphical object 520 is now in the gamer's line of sight to the real-world object 530. Also based on the gamer's current head pose and location, the graphical object 525 is in the is in the gamer's line of sight to the real-world object 540.

Absent present principles, excess light reflected and/or emitted by the objects 530, 540 at night might therefore pass through respective active elements (pixels) 540, 550 of the window 500 that are being used to present parts of the graphical objects 520, 524 using ambient backlight from external to the vehicle, corrupting the appearance of the objects 520, 525 owing to acute localized light throughput. This in turn could adversely impact the gamer's gameplay.

However, owing to the pixels 540, 550 (specifically, the liquid crystals) being individually controllable to modulate incoming light based on different external light amounts sensed by optical sensors adjacent to each respective pixel 540/550, the gaming system may control the pixels 540, 550 to let different amounts of light through each one at the same time to normalize the brightness levels across the pixels presenting the objects 520, 525. This may result in equal backlight throughput amongst the pixels. This may be done to limit the objects 530, 540 from otherwise increasing the backlight of some or all pixels used to present each of the objects 520, 525 in excess of the intended brightness level for the objects as output by the game engine itself. Thus, in implementing present principles, each object 520, 525 may still be rendered with a uniform or intended brightness level(s) across the entire respective object 520, 525 (at least to within a threshold tolerance in terms of luminance) for optical perception by the gamer 500 despite inconsistent light throughput for different pixels being used to present the respective object 520, 525. The aforementioned threshold luminance might be five lumens, for example.

Thus, each individual pixel of the display assembly that is used to present a portion of the object 520 or 525 may still present its respective portion of the object 520, 525 with a respective color that remains true to the source image from the computing device, while a respective opaqueness parameter is used for each pixel to control the backlight transmissibility of the pixel itself. In this way, only an amount of light needed to achieve the pixel brightness level indicated by the computing system is permitted to pass through that respective pixel.

Furthermore, note that modulating backlight in such a way may include not just making each individual pixel increasingly more opaque as needed to block acute and temporary backlight throughput from adversely affecting image quality, but also making each pixel increasingly less opaque to permit more backlight throughput when needed to increase virtual object brightness as well. For instance, when driving at night, there may be real-world background that appears completely black from the gamer's point of view. So here, the gaming system may modulate light throughput for pixels in the user's line of sight toward the real-world black background to be more transparent, letting additional ambient backlight through those pixels to normalize the backlight for those pixels with the backlight of other image portions that might be illuminated by acute (but still normalized) backlight.

Note that in some examples, the foregoing processes may be performed using an optimization and/or coordination AI model, which may provide outputs in the form of opaqueness parameters that are then usable by the device's display driver to modify the light going through each individual pixel. The model may infer the opaqueness parameters in a coordinated way to ensure relative brightness, color, etc. stays the same across a rendered image in the gamer's field of view.

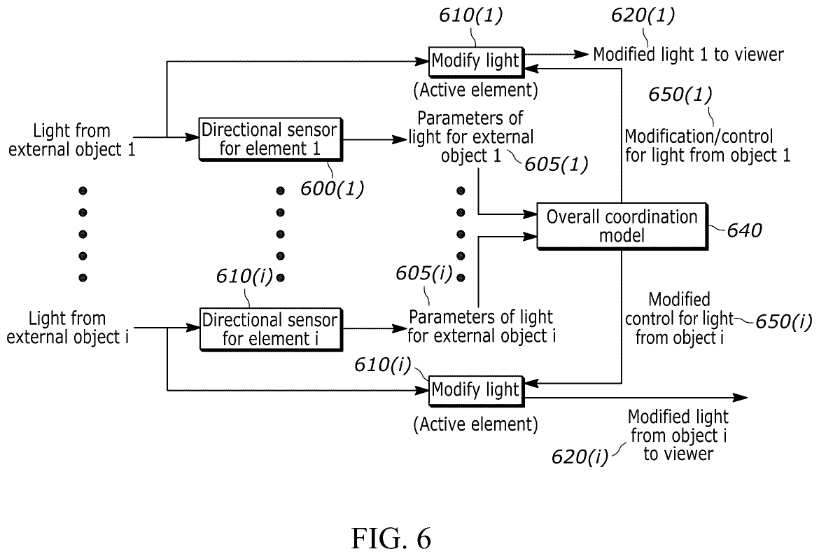

FIG. 6 shows another schematic diagram that further illustrates the overall flow of a vehicle display system consistent with present principles. FIG. 6 shows that light from external objects “1” to “i” may: (a) be sensed by a respective directional optical sensor 600 to provide one or more parameters 605 of light for the respective external object 1-i to a coordination model 640; and (b) be modified at 610 using a respective light-modifying active element (pixel with liquid crystals) 1-i to produce respective modified image backlight 620 1-i to a viewer as part of image rendering.

The backlight 620 itself may be allowed through each pixel according to a respective opaqueness parameter as determined by a coordination model 640. The model 640 may therefore be executed at 650 to modulate light from the respective external object as it passes through the pixel itself to thus present the modified light 620 1-i to the viewer.

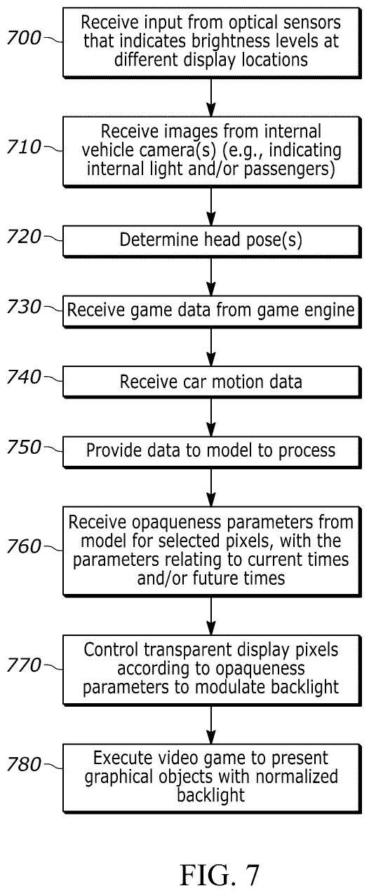

Continuing the detailed description in reference to FIG. 7, this figure shows example logic that may be executed by an apparatus such as a client device (vehicle or smartphone) and/or coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 7 is shown in flow chart format, other suitable logic may also be used.

Beginning at block 700, the apparatus may receive input from optical sensors in a transparent display assembly. The input from each sensor may indicate a light directionality and brightness level as sensed at that sensor, and hence indicate a brightness level and directionality at an associated pixel location adjacent to the respective sensor. From block 700 the logic may then proceed to block 710.

At block 710 the apparatus may receive images from one or more cameras that are inside the vehicle, such as a camera mounted on the rear-view mirror or interior ceiling of the vehicle. The camera(s) may be used to determine internal ambient lighting metrics for ambient light within the vehicle as well as to identify the head poses and locations of respective vehicle passengers at block 720. Head pose and location may be determined using computer vision and other image processing techniques, for example.

The logic may then proceed to block 730. At block 730 the apparatus may receive game data from a game engine being executed by the apparatus. The game data may be used to render video game objects to the vehicle's passengers visually on the window of the vehicle. The game data may therefore indicate respective graphical objects for rendering according to their predetermined brightness level(s) and color(s) as output by the game engine, with the output from the game engine also indicating respective display rendering locations for the respective graphical objects.

The logic may then move to block 740. At block 740 the apparatus may receive vehicle motion data, such as data from one or more an inertial measurement units (IMUs) on the vehicle that may each include an accelerometer, gyroscope, and/or magnetometer. The vehicle motion data may therefore indicate motion vectors for the vehicle itself. Current and future GPS coordinates from a navigational assistance application may also be used to determine the vehicle motion vectors.

The logic may then proceed to block 750. At block 750 the apparatus may provide the optical sensor input, vehicle internal lighting data, head pose and location data, game data, and car motion data to an artificial intelligence (AI) model so that the model can be executed to process the data to infer respective opaqueness parameters for some or all display pixels. Then at block 760 the apparatus may receive the inferred opaqueness parameters from the model for selected pixels.

Note here that some of the opaqueness parameters may relate to pixel opaqueness for a current time of day T0 at which the external light currently impinges respective sensors adjacent to the respective pixels. However, other inferred opaqueness parameters may instead relate to future times of day T1-Tn at which the apparatus is to control other pixels to modulate light from the same external light source. The model may therefore account for vehicle movement (as indicated in the vehicle motion data) as well as external light movement in 3D real space for seamless backlight normalization over time during video game image rendering.

In some examples, the model may even be trained prior to deployment to predict a light's movement and brightness across the window display over time. This in turn may be used to determine the future opaqueness parameters that compensate for the light's movement and brightness over time. As such, a training dataset may be used for training the model to make such inferences, where each data pairing in the training dataset includes data for light brightness level, light size and shape, light origin/direction, light movement across the display over time, and vehicle motion data. Each pairing may also include a respective ground truth light movement indicator and light brightness indicator for supervised learning.

Thus, during deployment, the computing device may input to the model current (T0) light brightness, size, shape, and directionality as determined from the optical sensor input, and input the car motion data, for the model to then predict future light movement across the window display in the window's X-Y plane. The model may then output opaqueness parameters for future times T1-Tn (as also dependent on the gamer's current head location and pose) so that the game objects may be rendered with normalized backlight according to the user's angle of view at times T1-Tn as well as at time T0.

Further note that in some examples, the opaqueness parameters may also be determined by the model based on interior lighting metrics associated with ambient light within the vehicle as well. Metrics for the interior lighting may be determined from the camera images received at block 710. This may be done to maintain a predetermined light contrast between the displayed game objects and the internal lighting environment within the vehicle so that the game objects can be seen in whatever internal ambient lighting conditions exist within the vehicle. Thus, in these implementations, the aforementioned model may also use internal ambient light as additional data for inferring current and future opaqueness parameters to normalize backlight consistent with the predetermined light contrast.

Still in reference to FIG. 7, the logic may move from block 760 to block 770. At block 770 the apparatus may control the transparent display pixels according to the opaqueness parameters received from the model to modulate external backlight through the transparent display at selected pixels. In some examples, this may be done while, at step 780, the apparatus also executes the video game to present the game objects themselves. However, further note that present principles are not limited to only video game object rendering and may be implemented for rendering other types of visual content as well.

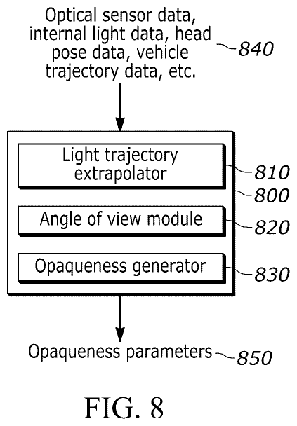

Now in reference to FIG. 8, example artificial intelligence (AI) architecture for a coordination AI model 800 is shown. The architecture of FIG. 8 may be implemented consistent with present principles, including with the logic of FIG. 7. However, the architecture is but one example configuration and other configurations are also encompassed by present principles.

As shown in FIG. 8, the AI architecture 800 may include a light trajectory extrapolator 810, an angle of view module 820, and an opaqueness parameter generator 830. Optical sensor data, internal vehicle ambient light data, head pose data, and vehicle trajectory data 840 may all be provided to the AI model 800 to receive back opaqueness parameters 850.

The extrapolator 810 may be established by a pattern recognition model such as one embodied in a convolutional neural network. The extrapolator 810 may have been trained on one or more datasets of light impingement display locations, light shape, light intensity, and associated light and vehicle motion vectors along with respective ground truth light movement indicators and light brightness indicators as mentioned above. The extrapolator 810 may therefore be trained to, during deployment, extrapolate future light brightness and motion in the X-Y dimensions across a transparent vehicle window display assembly.

The angle of view module 820 may be established by augmented reality (AR) and/or computer vision software that is configured to identify particular pixels whose opaqueness should be controlled at current and future times T0-Tn as part of image rendering. Those pixels may be identified according to the current X-Y display location of the detected light as well as the predicted future display locations output by the extrapolator 810. Also note that pixels may be excluded from dynamic backlight control based on the game data indicating that those pixels will not be used to present video game objects during the relevant period of time T0-Tn. The selected pixels identified by the module 820, as well as their respective light impingement times, may then be provided to the opaqueness parameter generator 830.

The generator 830 may then generate opaqueness parameters for the selected pixels for times T0-Tn. Note that the generator 830 may in some examples be established by a regression model that is executable to indicate different opaqueness parameters for different pixels for the same respective time of day, as well as different opaqueness parameters for those pixels over time.

As an example consistent with present principles, suppose light will go from not impinging a certain pixel to impinging that pixel to not impinging it again. Based on the predicted light trajectory and current head pose of the user, the opaqueness parameter generator 830 may output opaqueness parameters for that pixel to block increasingly more and then increasingly less light over time as the light moves over and then away from that pixel's location. In this way, the model 800 may be executed to maintain consistent backlight for image rendering using that pixel notwithstanding the momentary acute light impingement.

Moving on from FIG. 8, it is to be understood more generally consistent with present principles that a different AI model such as the model 800 may be trained and configured for each transparent display window of a vehicle, since light may behave differently for each window.

Also note consistent with present principles that where two passengers in a vehicle are playing the same game on a single window display, and hence their angles of view to the game objects are different, the system may normalize backlight according to both angles of view. This might result in more pixels having external backlight being modulated than for a single-person embodiment so that backlight can be modulated according to the light's directionality per both angles of view.

While the particular embodiments are herein shown and described in detail, it is to be understood that the subject matter which is encompassed by the present application is limited only by the claims.

What is claimed is:

1. An apparatus, comprising:
at least one processor system configured to:
receive first input from a first optical sensor and second input a second optical sensor, the first optical sensor located at a first location on a transparent display assembly and the second optical sensor located at a second location on the transparent display assembly;
process the first input to determine a first opaqueness parameter for a first pixel of the transparent display assembly, the first pixel being adjacent to the first location;
process the second input to determine a second opaqueness parameter for a second pixel of the transparent display assembly, the second pixel being adjacent to the second location;
based on the determination of the first opaqueness parameter, control the first pixel according to the first opaqueness parameter; and
based on the determination of the second opaqueness parameter, control the second pixel according to the second opaqueness parameter.

2. The apparatus of claim 1, wherein the transparent display assembly is integrated into a window of a vehicle.

3. The apparatus of claim 1, wherein the first and second inputs are processed to maintain a normalized brightness level for an image presented on the transparent display assembly using the first and second pixels.

4. The apparatus of claim 3, wherein the first opaqueness parameter indicates a different opaqueness amount than the second opaqueness parameter.

5. The apparatus of claim 4, wherein the at least one processor system is configured to:
process the first input to identify a first brightness level of light impinging on the first optical sensor;
determine the first opaqueness parameter to compensate for the first brightness level; and
process the second input to identify a second brightness level of light impinging on the second optical sensor; and
determine the second opaqueness parameter to compensate for the second brightness level.

6. The apparatus of claim 3, wherein the at least one processor system is configured to:
execute a model to process the first and second inputs to determine the first and second opaqueness parameters.

7. The apparatus of claim 6, wherein the at least one processor system is configured to:
based on a first brightness level of light currently impinging on the first optical sensor, extrapolate a second brightness level of light to impinge a third location of the transparent display assembly at a future time;
based on a third brightness level of light currently impinging on the second optical sensor, extrapolate a fourth brightness level of light to impinge a fourth location of the transparent display assembly at the future time; and
at the future time, control opaqueness of a third pixel according to a third opaqueness parameter for the second brightness level and control opaqueness of a fourth pixel according to a fourth opaqueness parameter for to the fourth brightness level.

8. The apparatus of claim 1, comprising the transparent display assembly.

9. The apparatus of claim 1, wherein the first and second optical sensors comprise photodiodes.

10. A method, comprising:
receiving input from first and second optical sensors that are disposed at different locations on a transparent display assembly;
based on the input, determining respective opaqueness parameters for first and second pixels of the transparent display assembly; and
controlling the first and second pixels according to the respective opaqueness parameters to normalize backlight in relation to one or more images presented on the transparent display assembly.

11. The method of claim 10, comprising:
determining a head pose of a passenger of a vehicle;
based on the head pose, selecting the first and second pixels to control the first and second pixels according to the respective opaqueness parameters.

12. The method of claim 11, comprising:
identifying one or more metrics for interior lighting within the vehicle; and
determining the respective opaqueness parameters based on the one or more metrics.

13. The method of claim 10, wherein a first opaqueness parameter for the first pixel is less than a second opaqueness parameter for the second pixel such that application of the first opaqueness parameter allows a first amount of light through the first pixel, and wherein the second opaqueness parameter is more than the first opaqueness parameter such that application of the second opaqueness parameter concurrently allows a second amount of light through the second pixel.

14. The apparatus of claim 13, wherein the first and second amounts of light are the same to within a threshold luminance.

15. The method of claim 10, comprising:
executing a model using the input to infer the respective opaqueness parameters for application at the first and second pixels at a time T1, the time T1 being later than a time T0 at which light impinges on the first and second optical sensors to generate the input.

16. An apparatus, comprising:
at least one computer readable storage medium (CRSM) that is not a transitory signal, the at least one CRSM comprising instructions executable by a processor system to:
receive input from first and second optical sensors that are disposed at different locations on a transparent display assembly;
based on the input, determine respective opaqueness parameters for first and second pixels of the transparent display assembly; and
control the first and second pixels according to the respective opaqueness parameters to modulate backlight in relation to one or more images presented on the transparent display assembly.

17. The apparatus of claim 16, comprising a vehicle, the vehicle comprising the transparent display assembly as integrated into a window of the vehicle.

18. The apparatus of claim 16, wherein the transparent display is integrated into a window of a vehicle, and wherein the instructions are executable to:
execute a video game configured for presentation in the vehicle; and
modulate the backlight while presenting the one or more images on the transparent display, the one or more images associated with the video game.

19. The apparatus of claim 16, wherein the instructions are executable to:
determine a head pose of a passenger of a vehicle;
based on the head pose, select the first and second pixels to control the first and second pixels according to the respective opaqueness parameters.

20. The apparatus of claim 16, wherein the instructions are executable to:
execute a model to process head pose data, interior lighting data, and optical sensor input to infer the respective opaqueness parameters for locations of the transparent display at which light currently impinging the transparent display elsewhere will impinge the transparent display in the future; and
receive one or more outputs from the model, the outputs indicating the respective opaqueness parameters; and
based on receipt of the outputs from the model, control the first and second pixels according to the respective opaqueness parameters.
